(19) United States
(12) Patent Application Publication
(10) Pub. No.: US 2005/0246946 A1
(43) Pub. Date: Nov. 10, 2005

(54) Ignition system for flammable material

(76) Inventor: Dennis M. Paplinski, Henderson, NV (US)

Correspondence Address: MCANDREWS HELD & MALLOY, LTD, 500 WEST MADISON STREET, SUITE 3400, CHICAGO, IL, 60661, US

(21) Appl. No.: 11/125,012

(22) Filed: May 9, 2005

Related U.S. Application Data
(60) Provisional application No. 60/569,111, filed on May 7, 2004.

(51) Int. Cl. F24B 3/00; A47J 37/00; C10L 11/00

(52) U.S. Cl. 44/544; 126/25 B

(57) ABSTRACT

An ignition system for flammable materials such as charcoal is provided. The ignition system includes a flammable paper tray that is infused with a non-petroleum palm oil wax accelerant. Substantially pure charcoal pieces are positioned in the tray at several predetermined charcoal positioning areas. The tray is ignited using multiple wicks.

### BACKGROUND OF THE INVENTION

The present invention generally relates to an ignition system for flammable materials. More specifically, the present invention relates to an ignition system for flammable materials such as charcoal for use in grilling.

Charcoal grilling is a pastime enjoyed by millions of consumers today and familiar to almost everyone. Typically, in order to grill, a charcoal grill is positioned outdoors, loaded with charcoal, and then the charcoal is ignited. Once the charcoal is fully ignited and is producing the desired heat for cooking, the charcoal is re-positioned in the grill and food is exposed to the heat of the charcoal and is cooked. Many consumers enjoy the taste of grilled foods, especially meats, as well as the experience of grilling.

However, one of the drawbacks to the present charcoal grilling experience is that, once the charcoal is first ignited, the charcoal is typically not ready for use in grilling food for some time. The delay between the initial ignition of the charcoal until the charcoal is ready for use in cooking can be as long as 20-25 minutes in some cases. A system that allows the charcoal to be ready for use in cooking in a lesser amount of time is highly desirable to a consumer.

In order to allow the charcoal to be ready for use in cooking faster, users sometimes expose the charcoal to an accelerant. For example, users frequently use a petroleum accelerant such as lighter fluid to pre-treat the charcoal. The use of an accelerant such as lighter fluid provides two important advantages. First, the flames of the ignition travel and are quickly delivered to many locations in the charcoal instead of the flame merely being introduced at the periphery of the charcoal and having to travel into the interior. Thus, more of the charcoal may begin the ignition process at the same time instead of having to wait for the flame to reach the charcoal. Second, the accelerant burns quickly and with a great deal of heat. The additional heat of the accelerant lessens the time required until the charcoal is ready for grilling.

Another prior art attempt to lessen the amount of time required before the charcoal is ready for grilling is using pre-treated charcoal. Perhaps the most well-known example of pre-treated charcoal is Matchlight®. In Matchlight®, the charcoal is pre-treated with a petroleum accelerant similar to diesel fuel which causes the charcoal to burn hotter. Due to the additional heat, the charcoal is ready for grilling faster.

However, although the accelerant may lessen the time required before the charcoal is ready for grilling, the use of a petroleum-based accelerant is not necessarily desirable. For example, a petroleum accelerant such as lighter fluid often soaks into the charcoal. Consequently, as the charcoal burns, the charcoal typically produces a smell that is often described as “chemical”. Additionally, the “chemical” smell is often smelled and tasted in food that is prepared using the charcoal. Additionally, some research suggests that the use of a petroleum accelerant may produce or enhance the production of carcinogens that may be found in the food after grilling. Similar drawbacks arise for pre-treated charcoal only more so because the pre-treated charcoal is typically more infused with the petroleum-based accelerant. Thus, a charcoal system that does not employ a petroleum-based accelerant is highly desirable.

Another drawback to present charcoal systems is that a user typically has a large bag of charcoal and must pour or individually place charcoal in the grill. Unfortunately, both pouring and placing the charcoal is typically messy for the user. For example, pouring the charcoal may release a large quantity of charcoal dust that may coat nearby surfaces and/or users. Additionally, individually placing the charcoal pieces requires a user to dirty their hands or to use special tools or gloves to prevent their hands from becoming dirty due to contact with the charcoal. Additionally, once the charcoal has fully ignited, the charcoal must typically be re-arranged in the grill, which may also be messy or unpleasant. These factors are important because, although charcoal grilling is often seen as a men's activity in American culture, survey research indicates that the messiness and unpleasantness of dealing with charcoal is a significant element holding back the expansion into the lucrative female market. Consequently, a charcoal system that allowed a user to position charcoal in a grill without the mess that accompanies the present activity is highly desirable.

Another drawback to present charcoal systems is that a user, especially an inexperienced user, may not be certain as to the amount of charcoal to add to a particular grill in order to optimize the cooking environment for that particular grill. Although generalized, unscientific methods such as “how hot does it feel to your hand” are common, in reality each grill is somewhat different. Factors such as horizontal or vertical size, the shape of the grill, the distance between the charcoal and the grilling surface, and many other factors may influence the heat received by the food from the charcoal. The result is that a user typically must become familiar with a certain type of grill and a certain type of charcoal in order to estimate the charcoal requirement needed to cook food on the grill. The learning curve may lead to disappointments when using a new grill for the first few times. Consequently, a charcoal system that matches the amount of charcoal to a specific grill size or grill style is highly desirable to a consumer.

Another drawback to present charcoal systems is that a user, often even an experienced user, is typically unable to ensure an even heat distribution across the majority of the grill surface. For example, irregularities in the positioning of the charcoal may channel heat to a specific location on the grill surface or some charcoal in one location may be burning hotter than charcoal in another location. Consequently, the uneven heat distribution may lead to non-uniformity in the cooking of the food, such as burning. Consequently, a charcoal system that provides a more regular heat distribution for the cooking surface is highly desirable to a consumer.

Finally, present charcoal pieces, such as charcoal briquettes, that are available to consumers typically include a large amount of fillers, such as clay. The filler such as clay is typically not consumed as the charcoal is burned and forms the overwhelming bulk of the residue left when burning the charcoal briquettes. Many users think that the large amount of ashy residue that is left over from grilling is the remnant of the charcoal, but they are somewhat mistaken. The ashy residue from burning the briquette is overwhelmingly composed of the filler portion of the briquette while the charcoal portion of the briquette typically is almost entirely consumed. Cleaning the grill and removing the ashy residue of the filler from the grill is typically a messy and undesirable task. The ashy residue is typically very light and easily becomes airborne where the residue may coat people or objects or even be inhaled. Obviously, reducing the percentage of filler in each charcoal briquette reduces the amount of ashy residue produced by the briquette. However, pure charcoal burns quite hot, and typical charcoal systems often include filler to reduce the burn temperature of the charcoal briquette to make the charcoal briquette usable for grilling food. Consequently, a charcoal system that reduces the amount of ashy residue produced during grilling is desirable to a user.

Thus, a need has long been felt for a charcoal system that provides a user with charcoal that is ready for cooking in a shorter amount of time, especially when the system does not employ a petroleum-based accelerant. Additionally, a charcoal system is highly desirable that allows a user to avoid the mess and unpleasantness of first positioning the charcoal in the grill, then re-positioning the charcoal once the charcoal is ready for grilling, and then cleaning the ashy residue out of the grill. Also, a charcoal system that matches the amount of charcoal to the grill and provides a more even heat distribution across the grilling surface is highly desirable.

### SUMMARY OF THE INVENTION

An ignition system for flammable materials such as charcoal is provided. The ignition system has a tray that is composed of a flammable material such as paper and is infused with a non-petroleum based accelerant such as palm oil wax. Charcoal pieces composed of substantially pure charcoal are positioned in the tray at several predetermined charcoal positioning areas. Multiple wicks are also included to assist in igniting the tray.

The ignition system provides charcoal that is ready for use in cooking in about eight (8) minutes without using a petroleum based accelerant. Additionally, the user merely positions the tray in the grill and need not touch the charcoal. Further, the tray burns cleanly and virtually no residue is left. Finally, pre-positioning the charcoal in the charcoal positioning areas matches the amount of charcoal needed to the grill and provides a more even heat distribution across the grilling surface.

### BRIEF DESCRIPTION OF THE DRAWINGS

FIG. 1 illustrates an ignition system for flammable material according to a preferred embodiment.

FIG. 2 is a perspective view of the ignition system of FIG. 1.

FIG. 3 is a top view of the tray of the ignition system of FIG. 1 with the charcoal pieces and wicks removed.

FIG. 4 illustrates a perspective view of the tray with the charcoal pieces and wicks removed.

FIG. 5 illustrates a preferred charcoal piece for use in the ignition system.

FIG. 6 illustrates a perspective view of the charcoal piece of FIG. 5 including the center aperture, spacing elements, and venting areas.

### DETAILED DESCRIPTION OF THE PREFERRED EMBODIMENT

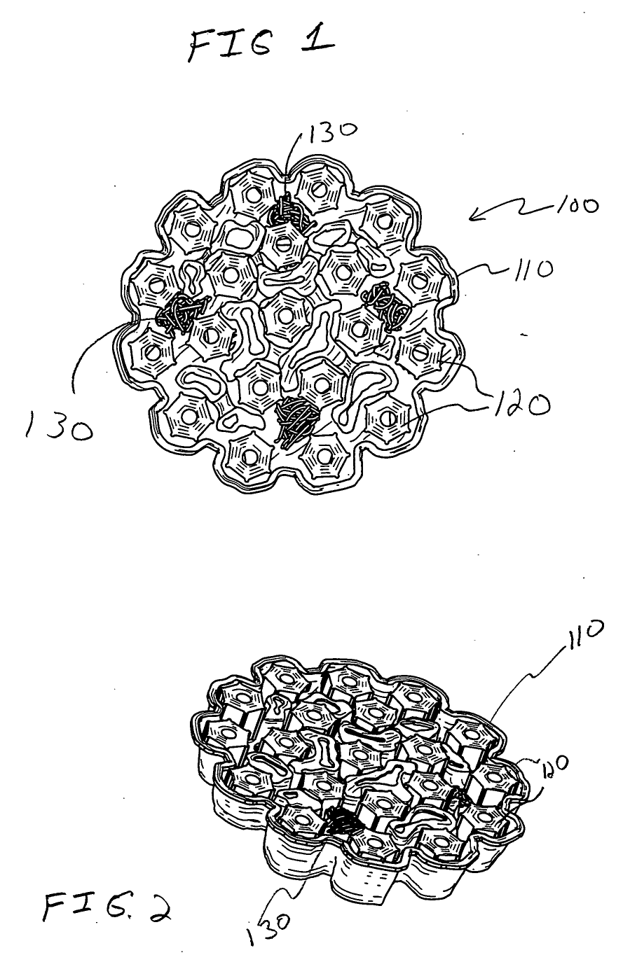

FIG. 1 illustrates a top view of an ignition system for flammable material 100 according to a preferred embodiment. The ignition system 100 includes a flammable tray 110, a plurality of flammable material elements 120 such as charcoal pieces, and a plurality of wicks 130. FIG. 2 is a perspective view of the ignition system 100 of FIG. 1.

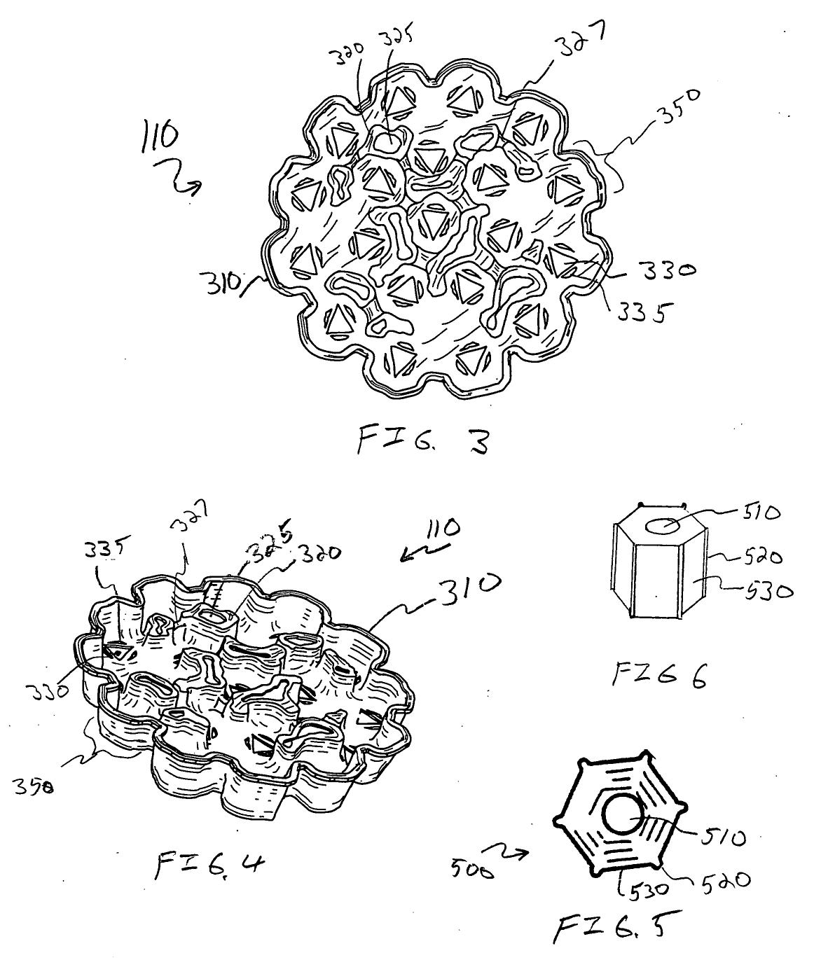

The flammable tray is preferably composed of a flammable material such as paper and is preferably treated or infused or coated with a non-petroleum accelerant such as palm oil wax. As shown in FIG. 1, the tray 110 includes a number of depressions or flammable material positioning areas where the charcoal pieces 120 are positioned. As further described below, the charcoal pieces 120 are preferably introduced into the tray and held into the tray by frictional contact between the charcoal piece 120 and the tray 110. Further aspects of the flammable tray 110 are discussed with regard to FIGS. 3-4, below.

The charcoal pieces 120 are preferably formed by extrusion. Additionally, the charcoal pieces preferably have a uniform cross-section including several flat edges, such as the hexagonal cylinder that is shown in FIG. 1. The corners of the hexagonal cylinder allow the charcoal piece to be friction fitted into the wax tray to stabilize the charcoal piece in the wax tray during transport and ignition. Additionally, the charcoal pieces 120 preferably do not include fillers, such as clay, as further described below.

The wicks 130 preferably are not connected to the tray, but are positioned in wick areas in the tray. Similar to the tray 110, the wicks 130 are also preferably composed of paper and treated, infused, or coated with a non-petroleum accelerant such as palm oil wax. However, the wicks are preferably composed of a much thinner paper than the tray 110, which makes the wicks 130 easier to light and faster to burn. The wicks are preferably very easy to start on fire and act like a candle wick allowing safe and gentle ignition of the tray before the tray fully engulfs to ignite the charcoal. Further, the wicks are preferably composed of shredded paper, but may include any flammable or combustible material such as wick material for use with candles. The wicks may also de described as lighting wicks, light up points, ignitions spots, or ignition device.

As shown in FIG. 1, preferably several wicks 130 are positioned in the tray 110 and a user would proceed to light each wick. More specifically, as shown in FIG. 1, four wicks are provide, one wick in each quadrant of the tray 110. Although only a single wick need be included, the use of multiple wicks causes the flame to spread throughout the tray even faster. Alternatively, the tray 110 may be used without wicks, in which instance users may simply light the tray itself.

In operation, the tray 110 is first placed in a charcoal grill, for example. Then the wicks 130 are lit, for example by using matches. As mentioned above, the wicks 130 are preferably composed of thick paper infused with palm oil wax. Consequently, the wicks 130 easily begin to burn, but burn more slowly and with more heat than paper alone. The flames from the wicks travel quickly over the tray and ignite the tray.

As the paper and palm oil wax of the wicks 130 burns, the burning of the wicks 130 causes the tray 110 to ignite. As mentioned above, the tray 110 is also composed of paper that has been infused with palm oil wax. However, the tray 110 is preferably composed of thicker paper than the wicks 130 and also is infused with a greater amount of palm oil wax than the wicks 130. As the paper and palm oil wax of the tray 110 burns, the charcoal pieces 120 are ignited.

FIG. 3 is a top view of the tray 110 of the ignition system of FIG. 1 with the charcoal pieces and wicks removed. As shown in FIG. 3, the tray 110 includes an outer rim 310, an plurality of inner risers 320, each including a riser vent aperture 325, and a plurality of flow depressions 327. Additionally, the tray 110 includes a plurality of charcoal positioning areas 350, each of which includes a charcoal piece center vent 330 and a plurality of charcoal piece side vents 335.

FIG. 4 illustrates a perspective view of the tray 110 with the charcoal pieces and wicks removed. The outer ring 310, inner risers 320, riser vent apertures 325, flow depressions 327, charcoal positioning areas 350, charcoal piece center vents 330 and charcoal piece side vents 335 are also shown.

As mentioned above, the tray is preferably composed of paper. However, the tray may be composed of any flammable material that is able to serve as a delivery mechanism or host for the non-petroleum based accelerant. For example, the tray may be made of paper mache or of wood, for example. Additionally, the tray 110 may be composed of more than one type of flammable material. For example, the base of the tray may be paper mache and the sides of the tray may be paper.

As mentioned above, the tray is infused or treated or coated with an non-petroleum based accelerant such as palm oil wax. Preferably, the tray is composed of paper and the paper tray is introduced into liquid palm oil wax. The liquid palm oils wax then soaks into the tray. The tray is then removed from the palm oil wax and is allowed to cool. As the tray cools, the palm oil wax hardens and binds with the tray. The palm oil wax is preferably stable at room and environmental temperatures. Similar materials may be used for the wicks.

However, once the tray is ignited, the palm oil wax is also ignited and at least a portion of the palm oil wax re-liquifies and flows into contact with the charcoal pieces. Thus, the burning wax produces additional heat by burning either near to or in contact with the charcoal. The additional heat causes the charcoal to be ready for grilling faster.

Specifically, as described above and as is well-known in the field of charcoal grilling, once charcoal is first ignited, a significant amount of time is required for the charcoal to fully ignite or “burn-down” and thus be ready for use in cooking. The amount of time required may be as great as 20-25 minutes for some types of charcoal. As mentioned above, there have been several attempts in the prior art to lessen the total amount of time from when the charcoal is first ignited to when the charcoal is ready for cooking. However, the prior art efforts typically rely on the use of petroleum based accelerants which may not be desirable due to smell and taste or health concerns.

Specifically, as mentioned above, the preferred accelerant for use in the tray is palm oil wax. Palm oil wax has been chosen in part because palm oil wax is safe for consumption. Indeed palm oil or palm oil wax is present in many edible products sold and consumed in the U.S. today and has been found to be safe for human consumption. Conversely, petroleum based accelerants have been linked in some research with carcinogens.

As an alternative to palm oil wax, some other wax product that is safe for human consumption, such as wax derived from vegetable, sunflower, or soybean oil may be employed. Alternatively, some non-wax accelerant may be used, such as a liquid. Additionally, the wax may be referred to as “organic” rather than non-petroleum based.

Alternatively, the tray may even be used with a petroleum-based accelerant such as paraffin wax. If the tray is used with a petroleum-based accelerant, the tray still assists in making the charcoal ready for grilling faster, but the user may be exposed to the possible carcinogens the arise from, burning the petroleum based accelerant.

FIG. 5 illustrates a top view of a preferred charcoal piece 500 for use in the ignition system 100. The charcoal piece 500 includes a center aperture 510, a plurality of spacing elements 520, and a plurality of venting areas 530.

FIG. 6 illustrates a perspective view of the charcoal piece 500 of FIG. 5 including the center aperture 510, spacing elements 520, and venting areas 530.

As shown in FIGS. 5 and 6, the charcoal piece 500 is substantially uniform in cross-section and is substantially cylindrical. As mentioned above, the charcoal piece 500 is preferably extruded. However, in alternative embodiments, the charcoal piece 500 may be formed by other processes, such as briquette-ing, for example.

As shown in FIG. 2 and discussed above, the charcoal piece 500 is introduced into the charcoal positioning areas 350 of the tray 110. As shown in FIGS. 3-4, the charcoal positioning areas 350 are substantially cylindrically shaped. Further, the charcoal positioning areas 350 are shaped so that the cylindrical radius is reduced with depth. Consequently, the charcoal pieces may be wedged into the charcoal positioning areas 350, as further described herein, and held into position with frictional force. At the sides of the bottom of the charcoal positioning areas 350 are the charcoal piece side vents 335. Preferably, the lower extent of the spacing elements 520 engage with the sides of the charcoal positioning areas 350 and/or the charcoal piece side vents 335 to hold the charcoal piece 500 into the tray.

Additionally, once the tray 110 is ignited, air passes through center aperture 510 of the charcoal piece 500 and the charcoal piece center vents 330 of the tray 110. The additional air flow allows the charcoal to burn faster. However, the thickness of the charcoal piece between air surfaces is preferably sufficient so that the charcoal piece is not burned faster than needed for practical use during cooking. Additionally, although the charcoal piece 500 preferably includes a center aperture, the present system may be constructed without a center aperture if desired. Additionally, although the center aperture is preferably in the center of the charcoal piece, the aperture may be offset from the center or multiple apertures may be provided.

Additionally, the charcoal pieces may be shaped differently in some alternative embodiments, such as star or octagon shapes. Further, the size of the spacing elements may be varied or the spacing elements may be partially or completely removed.

Although the center vents 330 are called vents, other terminology such as holes, ports, or venturies or any other term indicating the passage of air may also be used. Additionally, the burning produced by the airflow through the vents may be called by several terms including vortex, cyclone, whirlwind, controlled air flow, and controlled air action. Similarly, the effect of the air flow may be described as hotter, faster, or more intense.

Additionally, once the tray 110 is ignited, air passes through the charcoal piece side vents 335 in the tray 110. The spacing elements 520 of the charcoal piece 500 serve to provide clearance between the charcoal piece and the side of the tray in the charcoal position areas. Consequently, air may flow through the side vents 335 in the tray and up the venting areas 530 on the side of the charcoal piece 500.

Thus, the charcoal piece center vents 330 and the charcoal piece side vents 335 of the tray operate with the center aperture 510 and spacing elements 520 respectively of the charcoal piece to provide increase airflow for the charcoal piece and consequently to speed combustion of the charcoal piece.

Turning again to the tray 110 of FIGS. 3 and 4, as mentioned above, the tray 110 also includes inner risers 320 having riser vent apertures 325. The inner risers 320 are preferably lower than the outer rim 310. The riser vent apertures 325 provide additional airflow through the tray 110 in order to speed combustion of the charcoal piece.

FIGS. 3-4 illustrate one exemplary positional selection of the inner risers 320, but many alternate configurations are possible. The inner risers 320 are not uniformly distributed throughout the tray as shown in FIGS. 3-4, but may be more uniformly distributed in many alternate fashions in various alternate embodiments. For example, the inner risers 320 may be uniformly distributed throughout the tray, or may be arranged in concentric circles or other geometric patterns. Further, as shown in FIGS. 3-4, the inner risers are not uniform in size. However, in alternative embodiments, the inner risers may be uniform in size or of several different uniform sizes. Similarly, the riser vent apertures as shown in FIG. 3-4 do not occupy a uniform portion of the inner risers 320. However, in alternative embodiments, the riser vent apertures 325 may be uniform in size and shape or any of a plurality of uniform sizes and shapes.

Additionally, the inner risers 320 as shown in FIGS. 3-4 are preferably not substantially uniform in height and include flow depressions 327. The flow depressions 327 act to regulate the amount of liquefied palm oil wax that is present in a particular charcoal positioning area 350. More specifically, if the depth of liquid wax in a particular charcoal positioning area becomes greater than the height of the flow depression 327, the liquid wax flows through the flow depression 327 into a neighboring charcoal positioning area.

Further, the bottom of the charcoal positioning area accepts the palm oil as the palm oil wax melts and pools. The bottom of the charcoal positioning area includes an upward angle to the triangular charcoal piece center vent. The angle of the bottom helps to regulate the amount of palm oil that may accumulate in the charcoal positioning area. For example, if too much palm oil is accumulating in the charcoal positioning area, a desired quantity of palm oil may be retained in the charcoal positioning area while the additional palm oil may pass through the charcoal piece center vent.

Further, although the charcoal piece center vent is shown as triangular and the charcoal piece side vents are shown as having a flat side and a rounded side, the shape and position of the charcoal piece center vent and the charcoal piece side vent my vary. Further, either one or both of the charcoal piece center vent and the charcoal piece side vent may be eliminated, although this may deprive the tray of some advantages.

Turning again to the tray 110, the tray 110 is composed of paper and palm oil wax. Consequently, as the tray burns, the tray is typically completely consumed and “burns away” from the charcoal pieces. However, even after the tray has burned away, the charcoal pieces retain the relative position and spacing as the charcoal pieces were positioned in the tray 110.

Additionally, although the present ignition system is shown in its preferred embodiment utilizing charcoal, other flammable substances may partially or completely replace the charcoal. For example, in an alternative embodiment, some of the charcoal positioning areas may hold wood instead of charcoal. The addition of wood may be desirable to produce a certain flavor in he cooked food.

Additionally, the charcoal pieces 500 used in the tray 100 are preferably composed of substantially pure charcoal. As discussed above, most presently available charcoal briquettes includes a large percentage by weight of fillers such as clay. However, pure charcoal burns at a temperature higher than that of present charcoal briquettes. That is, the briquettes burn at a lower temperature than pure charcoal because the briquettes include the fillers.

However, pure charcoal burns at a temperature that is typically regarded at too hot for cooking food. Indeed, if pieces of pure charcoal are used in the same fashion as briquettes are typically used today (for example, stacked in a pile) then the pure charcoal is indeed too hot for use in cooking food. However, if the pieces of pure charcoal are properly spaced in the grill, the pure charcoal produces an even temperature that is proper for use with cooking.

Thus, the spacing of the charcoal pieces in the tray serves to establish the proper spacing between the pure charcoal briquettes so as to provide the proper temperature for cooking. Additionally, the size of the tray and the number and position of the charcoal pieces in the tray is variable for specific sizes and types of grills.

Thus, the user of the charcoal tray does not have to guess as to the temperature of the cooking surface or have to guess as to how much charcoal should be used. The user merely selects the tray 110 of appropriate size for their grill, places the tray in the grill and ignites the tray. As the tray ignites the charcoal, the tray is consumed, and the user is left with the charcoal pieces in the proper position for use in their grill.

Although the preferred embodiment described above is described with the use of substantially pure charcoal, less pure charcoal may be employed. Using substantially pure charcoal yields the lightest tray because the weight of the tray does not include the weight of any fillers. However, charcoal pieces with fillers may be employed, but such charcoal pieces result in a heavier tray and typically must be positioned closer together because the charcoal pieces with filters typically burn at a lesser temperature than pure charcoal.

Thus, by using the tray 110, the user does not need to engage in the messy and unpleasant task of initially positioning the charcoal in the grill prior to ignition. The user simply places the tray in the grill and ignites the tray. Thus, the use of the tray is “touchless” in that the user never needs to touch the charcoal.

Further, the tray is designed to allow the user to easily lift the tray from outer packaging and then easily position or manhandle the tray as the user desires. In this regard, the upper extent of the outer rim 310 preferably includes a ledge or tab that assists the user in holding the tray 110. Further, the contours and structure of the tray, including the triangular charcoal piece center vent 330 are engineered to provide strength to the tray.

Further, the thickness and density of the tray along with the amount of palm oil wax included in the tray is pre-determined to provide a mass of flammable material that burns away at a controlled, desired rate of time so that the tray fully ignites the charcoal before the tray is consumed.

Additionally, the user does not need to engage in the task of repositioning the charcoal once the charcoal is ready for cooking. Instead, the charcoal in the tray is prepositioned so that, once the tray ignites and burns away, the charcoal is properly positioned for grilling. That is, the heat provided by the charcoal is typically very uniform across the grilling surface. One reason that the heat is typically more even across the grilling surface using the present tray than using charcoal briquettes is because there is no surface between the charcoal producing the heat and the grilling surface that may cause the heat to be diverted. For example, when using briquettes, a first briquette may be positioned on top of a second briquette. Consequently, heat produced by the second briquette may be diverted around to the sides of the first briquette. Thus, the first briquette may serve to channel heat unevenly across the grilling surface.

Additionally, the user does not need to engage in the task of cleaning the grill before each use. As noted above, the charcoal pieces are preferably composed of substantially pure charcoal. Consequently, the charcoal pieces are substantially consumed as the charcoal burns. Thus, virtually none of the large amounts of ashy residue that is typically associated with grilling using charcoal briquettes results when the pure charcoal is burned. Consequently, the user need not engage in the messy and unpleasant task of emptying and cleaning the ashy residue from the grill. Using the present tray, cleanup is typically not required.

The ignition system 100 thus provides several advantages over the prior art. First, the palm oil wax (and to an extent, the paper of the tray) serve as an accelerant to cause the charcoal to be ready for use in cooking much faster than even the fastest commercially available charcoal with a petroleum-based accelerant. Specifically, tests have shown that the ignition system 100 of FIG. 1 causes the charcoal to be ready for cooking in about eight (8) minutes. The eight minute ignition time of the ignition system 100 of FIG. 1 is thus considerably better than the fastest petroleum accelerant infused charcoal, which still requires about 12-15 minutes for the charcoal to be ready for cooking.

Additionally, as mentioned above the use of non-petroleum based, organic palm oil wax instead of a petroleum based accelerant eliminates the “chemical” smell and taste and may eliminate or reduce the carcinogens that have been detected in some studies using petroleum based accelerants. In addition to the palm oil wax, the remainder of the tray is composed of paper and the charcoal is composed of wood without harmful fillers. Consequently, the tray does not include any harmful ingredients. A fact that has been tested and affirmed.

As a further advantage, the use of the tray is “touchless” in that direct contact with the charcoal is eliminated and contact with charcoal dust is greatly reduced. That is, as described above, the user only needs to touch the tray, not the charcoal, to position the charcoal in the grill. Nor does the user need to reposition the charcoal once the charcoal is ready for grilling because the charcoal is already positioned in the proper location as the tray is burned away. Finally, no messy cleanup is required because the tray and substantially pure charcoal are virtually entirely consumed. Consequently, a user avoids the messy contact with charcoal and charcoal dust.

Additionally, because the charcoal is substantially pure (including bio mass, but no fillers), the charcoal consequently burns longer than standard charcoal briquettes which typically include a high filler content.

Consequently, the prior art charcoal grilling system of lifting heavy bags of briquettes, hand placing the charcoal in a pile, soaking the charcoal with a petroleum based accelerant, lighting the charcoal, having to wait 15-25 minutes until the charcoal is ready and then having to reposition or spread the charcoal before cooking, is obsolete. Instead, the present ignition system is light (approximately 4 pounds or 2 kg) and easy to handle and includes the charcoal in a prepositioned configuration that allows a user to simply light a wick and then begin cooking after eight (8) minutes with typically no cleanup required. The ignition system of FIG. 1 is presently undergoing test marketing with large retailers such as Wal-Mart.

While particular elements, embodiments and applications of the present invention have been shown and described, it will be understood that the invention is not limited thereto since modifications may be made by those skilled in the art, particularly in light of the foregoing teachings. It is therefore contemplated by the appended claims to cover such modifications as incorporate those features which come within the spirit and scope of the invention.

1. An ignition system for use with charcoal including:
an ignition tray, wherein said ignition tray includes a non-petroleum based accelerant; and
at least one charcoal piece positioned in said ignition tray, wherein said accelerant accelerates the burning of said at least on charcoal piece.

2. The system of claim 1 wherein said ignition tray is composed at least in part of paper.

3. The system of claim 1 wherein said accelerant is an organic wax.

4. The system of claim 3 wherein said wax is palm oil wax.

5. The system of claim 1 further including at least one wick.

6. The system of claim 5 wherein said wick may be ignited by a user and the burning of said wick causes the ignition of said ignition tray.

7. The system of claim 5 wherein said wick includes a non-petroleum based accelerant.

8. The system of claim 1 wherein said ignition tray and accelerant are substantially fully consumed during ignition of said sat least one charcoal piece.

9. A method for preparing charcoal for use in cooking, said method including:
positioning an ignition tray, said ignition tray including a non-petroleum based accelerant and at least one charcoal piece; and
igniting said ignition tray so that said accelerant accelerates the burning of said at least on charcoal piece to prepare said at least one charcoal piece for cooking.

10. The method of claim 9 wherein said ignition tray is positioned in a grill.

11. The method of claim 10 wherein a user positions said ignition tray in said grill without contacting said at least one charcoal piece.

12. The method of claim 9 further including:
allowing said ignition tray and accelerant to burn until said ignition tray and said accelerant are substantially fully consumed.

13. The method of claim 9 further including:
cooking food using said at least one charcoal piece without re-positioning said at least one charcoal piece.

14. The method of claim 9 wherein said at least one charcoal piece includes a plurality of charcoal pieces.

15. The method of claim 14 wherein said ignition tray is positioned in a grill having a grill size and the number of said plurality of charcoal pieces included in said ignition tray is influenced by said grill size.

16. The method of claim 14 wherein said plurality of charcoal pieces are positioned in said tray to provide a substantially uniform heating surface for use in cooking.

17. A charcoal ignition acceleration system,
wherein said ignition acceleration system provides ready to cook charcoal in less than 10 minutes using an organic accelerant.

18. The system of claim 17 wherein said organic accelerant is palm oil wax.

19. The system of claim 17 wherein said organic accelerant and said charcoal are included in a tray.

20. The system of claim 19 wherein said tray is composed at least in part of paper.
